(19) United States
(12) Patent Application Publication
(10) Pub. No.: US 2021/0164597 A1
(43) Pub. Date: Jun. 3, 2021

(54) Clip

(71) Applicant: NORMA Germany GmbH, Maintal (DE)

(72) Inventors: Andreas Schweigert, Göttingen (DE); Tobias Stein, Göttingen (DE); Detlef Henrich, Limeshain (DE); Jason Walker, Hanau (DE); Viktor Stoll, Großkrotzenburg (DE); Nina Harm, Darmstadt (DE); Daniel Kintea, Frankfurt am Main (DE); Manfred Krüger, Büdingen (DE)

(21) Appl. No.: 17/052,281

(22) PCT Filed: Apr. 3, 2019
(86) PCT No.: PCT/EP2019/058339

§ 371 Date: Nov. 2, 2020

(30) Foreign Application Priority Data
May 2, 2018 (DE) 10 2018 110 530.4

(51) Int. Cl. F16L 33/035

(52) U.S. Cl. CPC F16L 33/035

(57) ABSTRACT

A clip has a clip strap which has a first edge and a second edge and a clamping device for clamping the clip strap. The clip strap has recesses which are arranged between the first edge and the second edge and are spaced apart. The clamping device has a guide channel designed so as to complement the clip strap, for guiding through the clip strap. The clamping device has at least one first sprung detent tongue having a first free end, which protrudes into the guide channel and is oriented obliquely with respect to a clamping direction of the clip strap predefined by the guide channel in such a way that when the clip strap is guided through the guide channel in the clamping direction, the first free end latches successively into recesses of the clip strap.

### INTRODUCTION

The disclosure relates to a clip having a clip band and having a clamping apparatus.

Clips of a variety of types are known from the prior art. Hose clips, for instance, serve for fastening various pipelines or hoses on corresponding connection pieces. To this end, the pipelines or hoses, and also the connection pieces, are pushed in one another and overlap in a connecting region. The hose clip engages around the connecting region and can press the two components to be connected against one another in a radial manner as a result of clamping of the clamping apparatus. As a result, in addition to the fixing thereof, a sealing of the connection is also effected.

The clamping action of the clamping apparatus is usually generated as a result of actuation of a clamping screw, which is received in a housing of the clamping apparatus in a rotatable manner. By way of example, in the case of a worm drive clip, a thread of the clamping screw makes it possible to move the clip band, which, on its outer side, comprises corresponding engagement means for the thread, in relation to the housing. In conventional hose clips, such a clamping screw acts on the clip band in a tangential direction and likewise requires the tangential introduction of a tool. As a result of the radially external arrangement of the housing with the clamping screw arranged therein, the clamping apparatus extends outwardly from the clip band in a very pronounced manner. This can be problematic in the case of confined installation conditions. In the case of confined space conditions, it is also difficult to position a tool tangentially and to connect it to the clamping screw.

Many other types of clips or related apparatuses are known. For the bundling of electrical lines, for example, use is often made of cable ties made of plastic, which can likewise be braced as a result of pulling of a band. However, cable ties of this kind are not suitable for installation environments with higher temperatures. The loosening of a cable tie in order to introduce further electrical lines can also be awkward.

### SUMMARY

It is an object of the disclosure to improve a clip of the type mentioned in the introduction to the effect that a considerably flatter construction in particular of the clamping apparatus, and also a more rapid assembly, is possible, wherein the opening of the clip is also intended to be as simple as possible.

To achieve the object, according to an embodiment, in the case of a clip having a clip band with a first border and a second border and having a clamping apparatus for clamping the clip band, wherein the clip band has a plurality of spaced-apart cutouts which are arranged between the first border and the second border, provision is made according to an embodiment of the disclosure for the clamping apparatus to comprise a guide channel which is designed to be complementary to the clip band and through which the clip band is guided, wherein the clamping apparatus comprises at least one first resilient latching tongue with a first free end which projects into the guide channel and which is oriented obliquely with respect to a clamping direction of the clip band, said clamping direction being prescribed by the guide channel, such that, when the clip band is guided through the guide channel in the clamping direction, the first free end latches successively into cutouts of the clip band and blocks a subsequent movement counter to the clamping direction.

Clips are usually equipped with a worm drive or a clamping screw connection, which have a rotatably mounted clamping screw and a corresponding thread on the clip band or on a separate screw element, wherein the screw projects radially outwardly from the clip band to a considerable extent and, for actuation, requires an interaction with a suitable tool. According to an embodiment of the disclosure, such a radially outwardly projecting clamping screw, which runs in a tangential direction relative to the clip band, is not necessary. Rather, it is possible to realize a very flat construction for the clamping apparatus, since the latter, for its function, requires neither a radially external clamping screw nor a direct interaction of the clamping apparatus with a tool. On account of a fundamentally very simple form, the first latching tongue can be formed from a bent sheet metal strip and can constitute an integral part of the clamping apparatus. The manufacture of the clamping apparatus can be simplified as a result. In addition, a simple latching of the latching tongue into the cutouts of the clip band becomes possible, which considerably facilitates not only the bracing of the clip but also the introduction of the clip band into the clamping apparatus. Guidance of the clip band through the guide channel leads to the free end of the first latching tongue engaging successively with the cutouts of the clip band. However, the oblique projection of the free end prevents a backward movement of the clip band, that is to say a relaxation. The size and the angle of the region adjoining the first free end of the first latching tongue can be adapted, in dependence on the dimensions of the clip band and of the cutouts, in order to optimize the required sliding force and in order to achieve a required holding force in the opposite direction. It is also not necessary to connect both ends of the clip band to the clamping apparatus prior to the attachment of the clip. In the case of an already established connection between hose or pipe components or in the case of already assembled lines, the clip according to an embodiment of the disclosure can also be attached in order to secure the connection or in order to bundle lines. The clip can also be preloaded by hand in a simple manner in that a user displaces the clip band in relation to the clamping apparatus or displaces the clamping apparatus in relation to the clip band, such that the first latching tongue latches at least into a first cutout or into successive cutouts and holds the position then set. Since the free end of the first latching tongue projects into the guide channel, the connection between the latching tongue and the relevant cutout can be effected only as a result of manual guidance of the free end out of the relevant cutout. To this end, a separate tool may be required. For the complete clamping of the clip, the use of a tool makes it possible to exert a high tensile force directly onto the clip band and/or the clamping apparatus, such that a desired bracing is effected.

In this connection, it is noted that the direction referred to above and below as “clamping direction” designates the movement of the clip band, said movement being suitable for the clamping of the clip. The clamping direction is prescribed by the clamping apparatus, and the arrangement of the individual regions of the clamping apparatus is prescribed substantially by the clamping direction. For this reason, some features are described with reference to the clamping direction. In particular, the clip band is moved from a side which lies counter to the clamping direction from other region to a side which lies along the clamping direction.

In one embodiment, the clamping apparatus comprises two spaced-apart first latching tongues, the first free ends of which are spaced apart from one another along the guide channel and which, when the clip band is guided through the guide channel in the clamping direction, alternately or simultaneously engage with the cutouts of the clip band. The two first latching tongues are consequently arranged at two different points of the guide channel and in each case latch into a cutout of the clip band, said cutout being aligned with the free end. As a result of selecting the spacing between the first latching tongues in such a way that the two first latching tongues alternately engage with cutouts, it is possible to achieve a finer gradation of the possible latching positions between the clip band and the clamping apparatus. To this end, it is not necessary, per an embodiment, to increase the number of cutouts and to inevitably adapt them in terms of their extent to a finer grid. With selection of the spacing of the latching tongues relative to one another in such a way that the two first latching tongues simultaneously engage with cutouts, it is possible for higher clamping forces to be absorbed.

The guide channel can also be configured to receive two layers of the clip band, wherein a first end of the clip band, which is provided for a radially internal layer, comprises a kink for fixed clamping to an end edge of the clamping apparatus. In this way, per an embodiment, an independent device for fastening a fixed end of the clip band, which will always be referred to below as the first end, is not necessary. The clip band can be guided through the clamping apparatus in a loose manner until the kink bears on or against the suitable end edge. Said end edge is arranged at an end of the guide channel, said end lying counter to the clamping direction. The clip is completed by introducing a second end of the clip band, said second end being arranged opposite the first end, into the guide channel. If the clip is fixedly clamped at the desired installation location, a region of the clip band, said region adjoining the first end, forms a first, radially internal layer in the guide channel. A radially external layer is formed by the pushed-through second end and the adjoining region of the clip band. Said radially external layer engages with the first latching tongue. As a result of the kink at the first end of the clip band, in addition to the frictional force arising between the individual layers, a form fit with the clamping apparatus is effected.

As an alternative or in addition thereto, per an embodiment, at an end of the guide channel, said end lying in the clamping direction, the clamping apparatus can comprise a latching lug which is configured to engage into a cutout of a first end of the clip band in order to hold the clip band on the clamping apparatus. The fastening of the clip band to the clamping apparatus can be produced or supported as a result of an engagement with the latching lug. In this case, the latching lug can be realized in various ways. It may be suitable to configure the latching lug in the form of a flat, web-like protrusion which extends radially outwardly from a base surface of the clamping apparatus, which comes into contact with the components to be connected. As a result of an overlap of the latching lug and of the first end of the clip band with a radially external layer of the clip band, and also the force which arises in a circumferential direction during clamping, it is possible to fix the connection. It may furthermore be suitable for the latching lug to additionally comprise a kinked region which extends in a circumferential direction, such that the latching lug forms a hook for receiving a cutout of the clip band.

In an embodiment, provision is made for an opening which is spaced apart from the latching lug counter to the clamping direction and which is configured for the insertion of the first end of the clip band. The clip band can consequently be inserted or plugged, by way of its first end, into the opening in order to be subsequently secured in the latching lug. As soon as the clip has been attached to the components to be connected to one another, as a result of the form fit both with the latching lug and with the opening, it is no longer possible to release the first end from the clamping apparatus. The opening can be realized as a simple slot, for example in a radially outwardly extending protuberance, or in the form of a sheet metal strip.

Counter to the clamping direction, the opening is followed by a ramp surface which faces the first latching tongue and which is configured, by way of the ramp surface, to radially outwardly deflect a second end of the clip band, which is inserted through an inlet, facing the first latching tongue, of the guide channel, and to guide said end out of the guide channel. In this case, the first end, which is fastened directly in or to the guide channel, of the clip band does not impede the sliding-through of the second end of the clip band. As a result of the ramp surface, the clip band can be deflected radially to a slight extent and can be easily gripped by the user.

In one embodiment, the clamping apparatus comprises a second resilient latching tongue, which is spaced apart from the first resilient latching tongue in the clamping direction, with a second free end which projects into the guide channel and which is oriented obliquely with respect to the clamping direction of the clip band, such that, when the clip band is guided through the guide channel counter to the clamping direction, the second free end latches into a cutout of the clip band and blocks a movement in the clamping direction. The second resilient latching tongue can be arranged in particular at an end of the clamping apparatus, said end being opposite an inlet which opens into the guide channel. By being plugged into said end, the clip band can bring about an engagement between a cutout of the clip band and the second free end, such that the clip band is subsequently fastened to the clamping apparatus. No separate fastening means or method steps are required in order to connect the clip band rigidly to the clamping apparatus. Such a development also permits the relatively simple release of the clip band at two different points of the clamping apparatus, such that, in a selected or prescribed installation position of the clip, a user is flexible.

If such a second latching tongue is employed, in the guide channel, there can be arranged an opening which delimits a movement of the clip band through a second inlet facing the second latching tongue into the guide channel counter to the clamping direction. Said opening can receive, and radially retain, the first end of the clip band. As a result of delimitation of the opening in a tangential direction, the first end can be plugged in only to a certain extent.

The opening can be delimited by a ramp surface which faces the first latching tongue and which, by way of a surface of the second latching tongue, said surface facing away from the guide channel, guides a first end of the clip band, which is inserted through the second inlet, out of the guide channel. The fastening of the clip band by way of the second latching tongue consequently does not lead to losses in terms of flexibility and handleability, per an embodiment. Only the length of the clip band, and also the circumference of the components to be connected to one another, delimits the section which can be pushed through the guide channel.

It is suitable for at least one of the at least one first latching tongue to be equipped with an engagement means, which faces away from the guide channel, for moving the free end of the relevant latching tongue out of the guide channel. In a particularly simple case, the engagement means can be embodied by a deep-drawn, longitudinally incised strip-shaped portion on the relevant latching tongue. Said portion includes a gap with respect to the surrounding region of the latching tongue, into which gap a screwdriver or another suitable tool for levering the relevant first latching tongue can be plugged.

The clip is produced from a metallic material. This can comprise in particular steel. A suitable workpiece for producing the clamping apparatus is a sheet metal, which can be produced, in particular without cutting, by way of multiple forming operations. The clamping apparatus is in one piece and not joined, that is to say no separate structural parts are connected to one another in order to produce the clamping apparatus. The at least one first latching tongue and, if desired, the second latching tongue could be produced by corresponding cutting or punching and forming.

The clip can in particular fulfill the function of a cable tie. A design made of a metallic material makes it possible to achieve a high temperature stability. At the same time, however, a subsequent attachment and a rapid and simple bracing can also be effected.

### BRIEF DESCRIPTION OF THE FIGURES

Further features, details and advantages of the disclosure emerge from the wording of the claims and from the following description of exemplary embodiments with reference to the drawings, in which:

FIG. 1 shows a three-dimensional illustration of a clamping apparatus of a first embodiment of a clip,

FIG. 2 shows a lateral partial section of the first embodiment of the clip,

FIG. 3 shows a three-dimensional illustration of a clamping apparatus of a second embodiment of a clip,

FIG. 4 shows a lateral partial section of the second embodiment of the,

FIG. 5 shows a three-dimensional illustration of a clamping apparatus of a third embodiment of a clip,

FIG. 6 shows a lateral partial section of the third embodiment of the clip.

### DETAILED DESCRIPTION

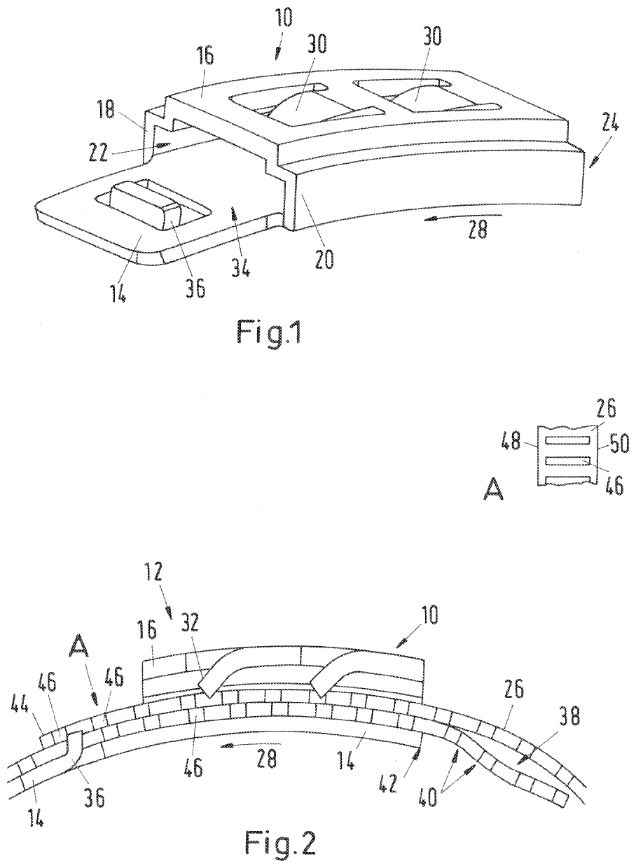

FIG. 1 shows a clamping apparatus 10 of a clip 12 from FIG. 2. The clamping apparatus 10 comprises a base surface 14, which forms a radial inner side. The base surface 14 has a curvature which is matched to the intended use or to a pipeline or hose line to be connected or one or more electrical lines. A radially external top surface 16, along with the base surface 14 and two side surfaces 18 and 20 which lie opposite one another and run between the base surface 14 and the top surface 16, encloses a guide channel 22. The guide channel 22 has an inlet 24, through which a complementarily formed clip band 26, which is shown in FIG. 2, can be plugged into the guide channel 22 along a clamping direction 28.

Two first resilient latching tongues 30 are arranged, spaced apart from one another along the clamping direction 28, on the top surface 16 and in each case comprise a first free end 32 which projects into the guide channel 22. The two first latching tongues 30 are bent or kinked sheet metal portions which run in an oblique manner, with respect to the clamping direction 28, into the guide channel 22. By way of example, the first latching tongues are formed by a portion of the top surface 16 and are oriented, by forming, obliquely with respect to the top surface 16 or the clamping direction 28.

An outlet 34 from which the clip band 26 can exit from the guide channel 22 again is located on a side of the clamping apparatus 10, said side facing away from the inlet 24. There, the clamp band can be gripped with a tool, for instance a tong or another force-fitting or form-fitting apparatus, in order to carry out a fixed bracing. Provision is made for a latching lug 36 which is spaced apart from the outlet 34 in the clamping direction 28 and with which the clip band 26 can be brought into engagement. This is illustrated further below with reference to FIG. 2.

In the lateral partial section in FIG. 2, a first end 38 of the clip band 26 can be seen, which has a slight kink 40. Said kink can be brought into contact with an end edge 42 of the clamping apparatus 10. The clip band 26 comprises a second end 44 which is opposite the first end 38. In the illustration shown, the kink 40 is located close to the end edge 42, such that the first end 38 is spaced apart from the guide channel 22 counter to the clamping direction 28. The clip band 26 extends over the base surface 14 through the guide channel 22 and is bent in a ring-shaped manner, such that the second end 44 once again projects through the guide channel 22. Within the guide channel 22 and in certain regions both counter to and along the clamping direction 28, two layers of the clamping band 26 overlap. In this case, the second end 44 lies radially on the outside, whereas the first end 38 lies radially on the inside.

By way of example, the clip band 26 comprises cutouts 46, which are shown in a detail A. The cutouts 46 are lined up, between a first border 48 and a second border 50 of the clip band, so as to be spaced apart from one another along the clip band 26. The cutouts 46 can be arranged in particular in a regular grid. The illustration of the cutouts 46 is merely exemplary; manifold other variants are conceivable as long as the cutouts 46 and the first latching tongues 30 are designed to be complementary to one another.

The first free ends 32 of the first latching tongues 30 are configured, as a result of the configuration of the first latching tongues 30, in such a way that the radially outer layer of the clip band permits the engagement of the first free ends 32 into the cutouts 46. On account of the shown orientation of the first latching tongues 30 obliquely with respect to the clamping direction 28, a sliding-through of the clip band 26 is easily possible, wherein the first free ends 32 alternately latch into cutouts 46 or are moved, from an edge, arranged counter to the clamping direction 28, of a cutout 46 which is engagement, in the clamping direction 28 in order to subsequently latch into a subsequent cutout 46. A reverse movement is prevented by the first latching tongues 30, just like by a barb.

The two first latching tongues 30 are spaced apart from one another such that the first free ends 32 do not necessarily latch into cutouts 46 in a simultaneous manner, but rather in an alternating manner. In this way, in spite of a constant spacing between the cutouts 46, the possible latching positions can be more finely gradated than with merely a single first latching tongue 30.

As a result of the fixed clamping of the clip 12, the radially inner layer of the clip band 26, said layer comprising the first end 38, is fixed. In addition thereto, one of the cutouts 46 can enter into engagement with the latching lug 36, for example. If the radially inner layer of the clip band 26 is fixed in a radial direction, the clip band 26 cannot slip in a circumferential direction.

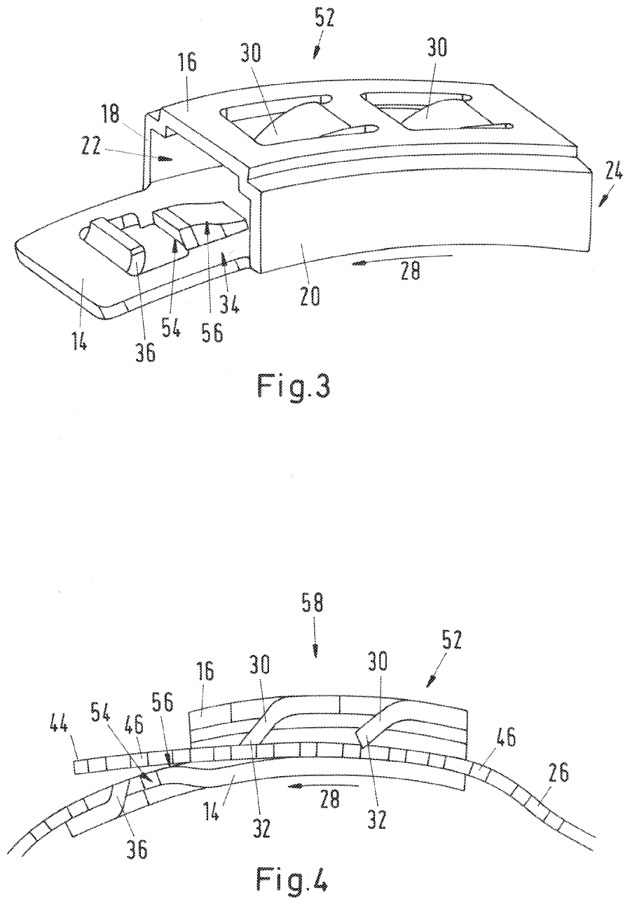

FIG. 3 shows a modification in the form of a clamping apparatus 52, which fundamentally has a similar construction to the clamping apparatus 10. In FIG. 3, the same reference designations are therefore provided for portions or structural part regions of the clamping apparatus 52 which can also be found in the clamping apparatus 10. A difference is that provision is made for an opening 54 which is spaced apart from the latching lug 36 counter to the clamping direction 28 and which is configured for the insertion of the first end 38 of the clip band 26. In this way, the position of the clip band 26 can be fixed in the radial direction. An overlap with the clip band 26 in the guide channel 2 is therefore not necessary and is also not implemented in this embodiment. In order not to impede the guiding-out of the second end 44 of the clip band 26, the opening 54 is arranged, for example, at a ramp surface 56 which is arranged against the clamping direction 28 and which is embodied for example as a radially outwardly directed bulge. In this way, the second end 44 of the clip band 26 can be pushed on tangentially and, as a result thereof, can be radially outwardly deflected to a slight extent.

FIG. 4 shows a resulting clip 58, in which the clip band 26 is in engagement with one of the first latching tongues 30 and the latching lug 36, wherein the first end 44 is moved beyond the latching lug 36 in the clamping direction 28.

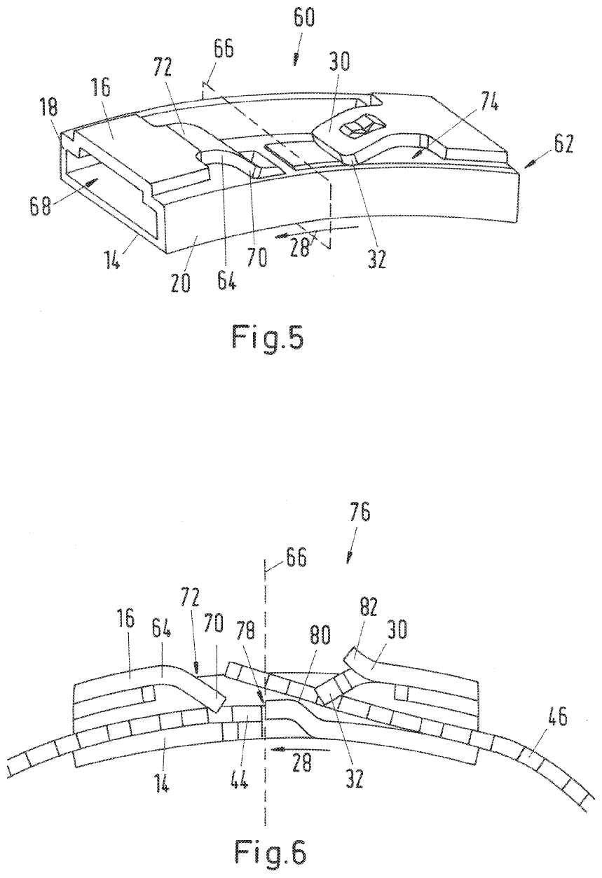

FIG. 5 shows a further variant of a clamping apparatus 60. The basic construction is similar to in FIG. 1 or FIG. 3; however, the clamping apparatus 60 comprises merely a single first latching tongue 30, which is arranged at a first inlet 62 and can engage into cutouts 46 of a clip band 26 which is guided into the first inlet 62. On an opposite side of the clamping apparatus 60, there is arranged a second latching tongue 64 which likewise runs obliquely with respect to the clamping direction 28. The latching tongues 30 and 64 enclose, with a common tangent of the clamping direction 28, or the top surface 16 or the base surface 14, two apex angles of identical magnitude, for example. This means that the latching tongues 30 and 64 are arranged in a substantially mirror-inverted manner relative to one another. A mirror plane 66 which determines the mirroring is formed in this case by a plane which intersects an aforementioned tangent formed centrally between the latching tongues 30 and 64 and which extends perpendicularly with respect to said tangent in a radial direction.

A second inlet 68 is located in a region adjoining the second latching tongue 64. Here, the first end 44 of the clip band 26 can be introduced in order to come into engagement with a second free end 70 of the second latching tongue 64. Accordingly, the clip band 26 can be fastened to the clamping apparatus 60 by way of the second latching tongue 64, instead of by fixed clamping or by a latching lug 36. The second end 38 of the clip band 26, which is plugged into, and pushed through, the inlet 62, can be guided out by way of a surface 72 of the second latching tongue 64, said surface facing toward the first latching tongue 30. A guide channel 74 is consequently formed from the inlet 62 as far as the surface 72 of the second latching tongue 64.

Finally, FIG. 6 shows a clip 76, in which the clamping apparatus 60 has been completed with the clip band 26. It can further be seen that the first end 44 of the clip band 26 has been plugged into an opening 78 which is formed at a ramp surface 80 arranged counter to the clamping direction 28. This is embodied analogously to the illustration in FIG. 3 and FIG. 4. As a result of the ramp surface 80, the second end 44 of the clip band 26 can be radially outwardly deflected to a slight extent by tangential pushing on, in order to subsequently reach to the outside by way of the surface 72 of the second latching tongue 64.

On the first latching tongue 30, it is further possible to see an engagement means 82 which facilitates the plugging-in of a tool, for instance of a screwdriver. As a result of corresponding levering or another similar action, the first latching tongue 30 can be released from engagement with a cutout 46.

The invention is not restricted to one of the embodiments described above, but rather can be modified in various ways.

All of the features and advantages, including structural details, spatial arrangements and method steps, arising from the claims, the description and the drawing may be essential to the invention both alone and in a variety of combinations.

All the features and advantages, including structural details, spatial arrangements and method steps, which follow from the claims, the description and the drawing can be fundamental to the invention both on their own and in different combinations. It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

### LIST OF REFERENCE DESIGNATIONS

10 Clamping apparatus

12 Clip

14 Base surface

16 Top surface

18 Side surface

20 Side surface

22 Guide channel

24 Inlet

26 Clip band

28 Clamping direction

30 First latching tongue

32 First free end

34 Outlet

36 Latching lug

38 First end

40 Kink

42 End edge

44 Second end

46 Cutout

48 First border

50 Second border

52 Clamping apparatus

54 Opening

56 Ramp surface

58 Clip

60 Clamping apparatus

62 First inlet

64 Second latching tongue

66 Mirror plane

68 Second inlet

70 Second free end

72 Surface

74 Guide channel

76 Clip

78 Opening

80 Ramp surface

82 Engagement means

1. A clip having a clip band with a first border and a second border and having a clamping apparatus for clamping the clip band, wherein the clip band has a plurality of spaced-apart cutouts which are arranged between the first border and the second border, wherein the clamping apparatus comprises a guide channel which is designed to be complementary to the clip band and through which the clip band is guided, wherein the clamping apparatus comprises at least one first resilient latching tongue with a first free end which projects into the guide channel and which is oriented obliquely with respect to a clamping direction of the clip band, the clamping direction being prescribed by the guide channel, such that, when the clip band is guided through the guide channel in the clamping direction, the first free end latches successively into cutouts of the clip band and blocks a subsequent movement counter to the clamping direction.

2. The clip as claimed in claim 1, that wherein the clamping apparatus comprises two spaced-apart first latching tongues, the first free ends of which are spaced apart from one another along the guide channel and which, when the clip band is guided through the guide channel in the clamping direction, alternately engage with the cutouts of the clip band.

3. The clip as claimed in claim 1, wherein the guide channel is configured to receive two layers of the clip band, wherein a first end of the clip band, which is provided for a radially internal layer, comprises a kink for fixed clamping to an end edge of the clamping apparatus.

4. The clip as claimed in claim 1, wherein, at an end of the guide channel, said end lying in the clamping direction, the clamping apparatus comprises a latching lug which is configured to engage into a cutout of a first end of the clip band in order to hold the clip band on the clamping apparatus.

5. The clip as claimed in claim 4, wherein provision is made for an opening which is spaced apart from the latching lug counter to the clamping direction and which is configured for the insertion of the first end of the clip band.

6. The clip as claimed in claim 5, wherein, counter to the clamping direction, there follows a ramp surface which faces the first latching tongue and which is configured, by way of the ramp surface, to radially outwardly deflect a second end of the clip band, which is inserted through an inlet, facing the first latching tongue, of the guide channel, and to guide said end out of the guide channel.

7. The clip as claimed in claim 1, wherein the clamping apparatus comprises a second resilient latching tongue, which is spaced apart from the first latching tongue in the clamping direction, with a second free end which projects into the guide channel and which is oriented obliquely with respect to the clamping direction of the clip band, such that, when the clip band is guided through the guide channel counter to the clamping direction, the second free end latches into a cutout of the clip band and blocks a movement in the clamping direction.

8. The clip as claimed in claim 7, wherein, in the guide channel, there is arranged an opening which delimits a movement of the clip band through a second inlet facing the second latching tongue into the guide channel counter to the clamping direction.

9. The clip as claimed in claim 8, wherein the opening is delimited by a ramp surface which faces the first latching tongue and which, by way of a surface of the second latching tongue, said surface facing away from the guide channel, guides an end of the clip band, which is inserted through the second inlet, out of the guide channel.

10. The clip as claimed in claim 1, wherein at least one of the at least one first latching tongue is equipped with an engagement means, which faces away from the guide channel, for moving the free first end of the relevant latching tongue out of the guide channel.

11. The clip as claimed in claim 1, wherein the clip is produced from a metallic material.
